(19) United States
(12) Patent Application Publication
(10) Pub. No.: US 2014/0115611 A1
(43) Pub. Date: Apr. 24, 2014

(54) TESTING DEVICE AND METHOD

(71) Applicants: HONG FU JIN PRECISION INDUSTRY (ShenZhen) CO., LTD., (US); HON HAI PRECISION INDUSTRY CO., LTD., New Taipei (TW)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/863,417

(22) Filed: Apr. 16, 2013

(30) Foreign Application Priority Data
Oct. 23, 2012 (CN) 201210405004.9

(51) Int. Cl. G11B 17/04

(52) U.S. Cl. CPC G11B 17/0407
USPC 720/602

(57) ABSTRACT

A testing method tests a disc loading and transferring mechanism having a tray. The testing method includes steps of: transmitting a tray-out instruction and a tray-in instruction in that order to drive the tray to alternate between a closed position and a opened; counting a first period of the tray moving from the closed position to the opened position and a second period of the tray moving from the opened position to the closed position; determining whether the first counted period and the second counted period are in conformity with predetermined and expected standards, and outputting test results for indicating the disc loading and transferring mechanism is not in conformity with predetermined and expected standards when the first counted period and the second counted period are in conformity with predetermined and expected standards.

### BACKGROUND

1. Technical Field

The present disclosure relates to testing technology, particular to a testing device and a testing method for testing a traverse module.

2. Description of Related Art

A traverse module is a major component of a disc drive. The traverse module includes a disc loading and transferring mechanism. The life of the disc loading and transferring mechanism affects the quality of the traverse module. Therefore, during production of the disc drive, the disc loading and transferring mechanism needs to be tested. However, the method for testing the disc loading and transferring mechanism is to manually drive a tray of discs inwards and outwards, to load and eject, this takes an inordinate amount of time.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a disc loading and transferring mechanism.

FIG. 2 is a function block diagram of a disc loading and transferring mechanism.

FIG. 3 is a chart of GUI (graphic user interface) provide by the disc loading and transferring mechanism.

FIG. 4 is a chart of a testing result provide by the disc loading and transferring mechanism.

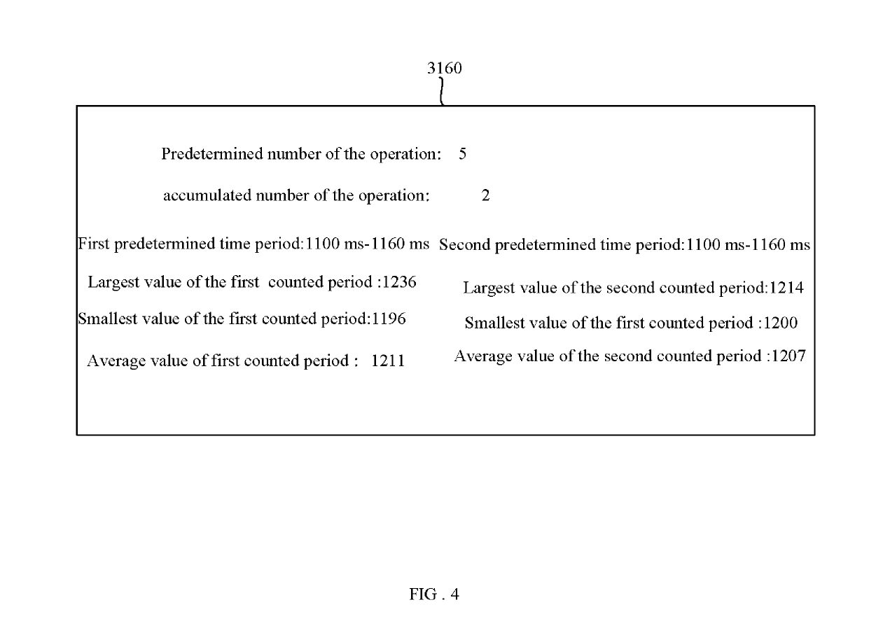

FIG. 5 is a flowing chart of a testing method for testing the disc loading and transferring mechanism.

### DETAILED DESCRIPTION

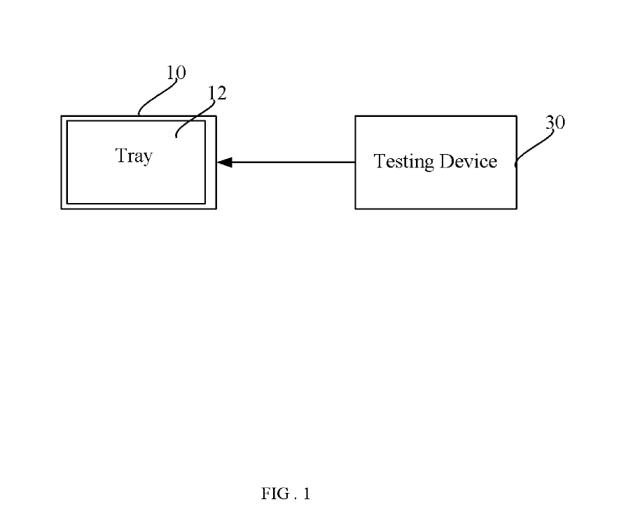

FIG. 1 shows an embodiment of a testing device 30. The test device 30 is configured to test a disc loading and transferring mechanism 10. The disc loading and transferring mechanism 10 includes a transferring member (not shown), and a tray 12. The tray 12 is configured to load a disc (not shown). The transferring mechanism drives the tray 12 to move inward loading the disc to reach a closed position and drives the tray 12 to move outward to reach an opened position. In this embodiment, an original state of the disc loading and transferring mechanism 10 is that the tray 12 is in the closed position.

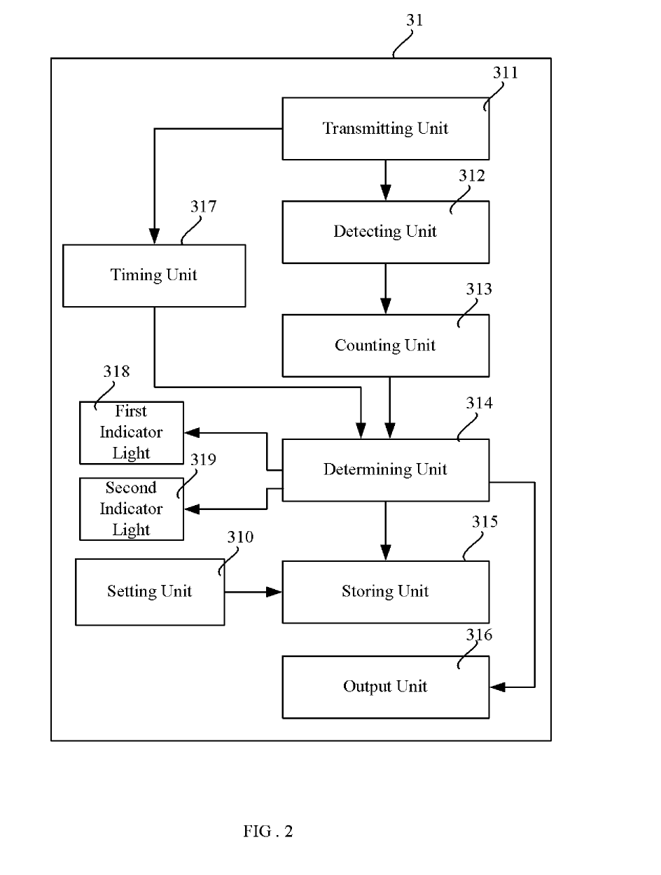

FIG. 2 shows that the testing device 30 includes a setting unit 310, a transmitting unit 311, detecting unit 312, a counting unit 313, a determining unit 314, a storing unit 315, an output unit 316, a timing unit 317, a first indicator light 318, and a second indicator light 319.

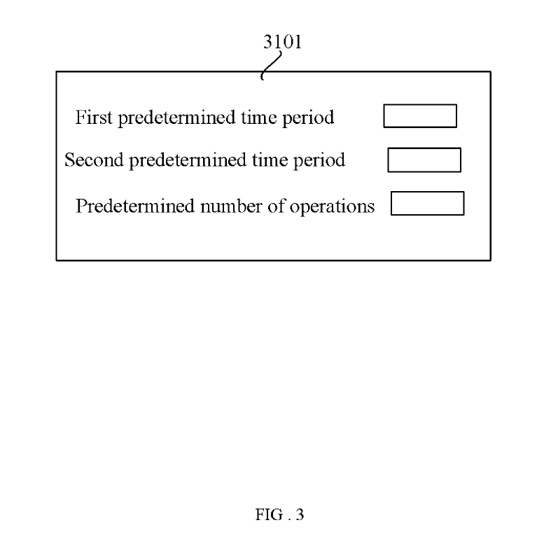

FIG. 3 shows that the setting unit 310 is provided with a graphic user interface (GUI) 3101 to enable a user to set a predetermined number of operation times, a first predetermine time period of the tray 12 moving from the closed position to the opened position, and a second predetermined time period of the tray 12 moving from the opened position to the closed position, and stores the predetermined number of operation times, the first predetermined time period and the second predetermined time period in the storing unit 315. In this embodiment, the predetermined number of the operation is 5. The first predetermined time period and the second predetermined time period are 1100 ms-1160 ms. When the tray 12 moves from the closed position to the opened position and back to the closed position, a count of one operation is recorded.

When the testing device 30 is started up, the transmitting unit 310 transmits tray-out and tray-in instructions to the disc loading and transferring mechanism 10 to drive the tray 12 from the closed positioned to the opened position and back to the closed position for predetermined operation times. The transmitting unit 310 further transmits the tray-out instruction, a first timing instruction, and a first detecting instruction. Because the disc loading and transferring mechanism 10 is lubricated when the disc loading and transferring mechanism 10 is manufactured, the lubricant will affect the speed of the tray 12 when the tray 12 moves inward and outward initially. Therefore, after the tray 12 has moved from the closed position to the opened position and back to the closed position for the predetermined operation times, the testing device 30 begins to test the disc loading and transferring mechanism 10. How the testing device 30 tests the disc loading and transferring mechanism 10 will be described below.

In response to the first timing instruction, the timing unit 317 begins to count a first period of the tray moving from the closed position to the opened position in response to the first timing instruction.

In response to the first detecting instruction, the detecting unit 312 detects when the tray reaches the opened position. The detecting unit 312 further generates a first determining instruction when the tray reaches the opened position. For example, the detecting unit 312 includes a sensor which can detect the tray 12 when the tray 12 reaches the opened position.

In response to the first determining instruction, the timing unit 317 ends the counting of the first time period and the determined unit 314 determines whether the first counted period is within the first predetermined time period. The determining unit 314 further generates a first stop instruction when the first counted period is outside the first predetermined time period. The determining unit 314 further generates a first control instruction when the first counted period is within the first predetermined time period.

In response to the first control instruction, the transmitting unit 311 further transmits the tray-in instruction to the disc loading and transferring mechanism 10 to drive the tray 12 to move from the opened position to the closed position, transmits a second detecting instruction to the detecting unit 312, and a second timing instruction to the timing unit 317.

In response to the second timing instruction, the timing unit 317 begins to count a second period of the tray 12 moving from the opened position to the closed position.

In response to the second detecting instruction, the detecting unit 312 detects when the disc loading and transferring mechanism 10 reaches the closed position, and generates a second determining instruction.

In response to the second determining instruction, the timing unit 317 stops counting the second period and the determining unit 314 determines whether the second counted period is within the second predetermined time period, and generates a counting instruction when the second counted period is with the second predetermined time period. The determining unit 314 further generates a second stop instruction when the second counted period is outside the second predetermined time period.

In response to the counting instruction, the counting unit 313 counts a number of an actual number of operations, and generates a third determining instruction. In this embodiment, the actual number of the operations begins at 0, and an increment of one is added to the operations after the counting unit 313 has counted one operation.

In response to the third determining instruction, the determining unit 313 determines whether the actual accumulated number of the operations reaches the first predetermined number. The determining unit 313 further generates an ending instruction when the accumulated number of the operations reaches the first predetermined number, and generates the tray-out instruction to continually detect the disc loading and transferring mechanism 10 when the actual accumulated number of the operations does not reach the first predetermined number.

In response to the first and the second stop instructions, the first indicator light 318 turn on, and the second indicator light 319 turns off, the output unit 316 outputs test results 316. The test results 3160 show the predetermined number of operation times, the first predetermined time period, the second predetermined time period, the accumulated number of operations, the first counted period, and a second counted period. The test results and the indicator light 318 indicate that the disc loading and transferring mechanism 10 is not in conformity with predetermined and expected standards.

In response to the ending instruction, the first indicator light 318 turns off and the second indicator light 319 turns on, and the output unit 316 outputs corresponding test results. The test results and the indicator light 319 indicate that the disc loading and transferring mechanism 10 is in conformity with predetermined and expected standards. In this embodiment, the first indicator light 318 and the second indicator light 319 emits different color lights respectively.

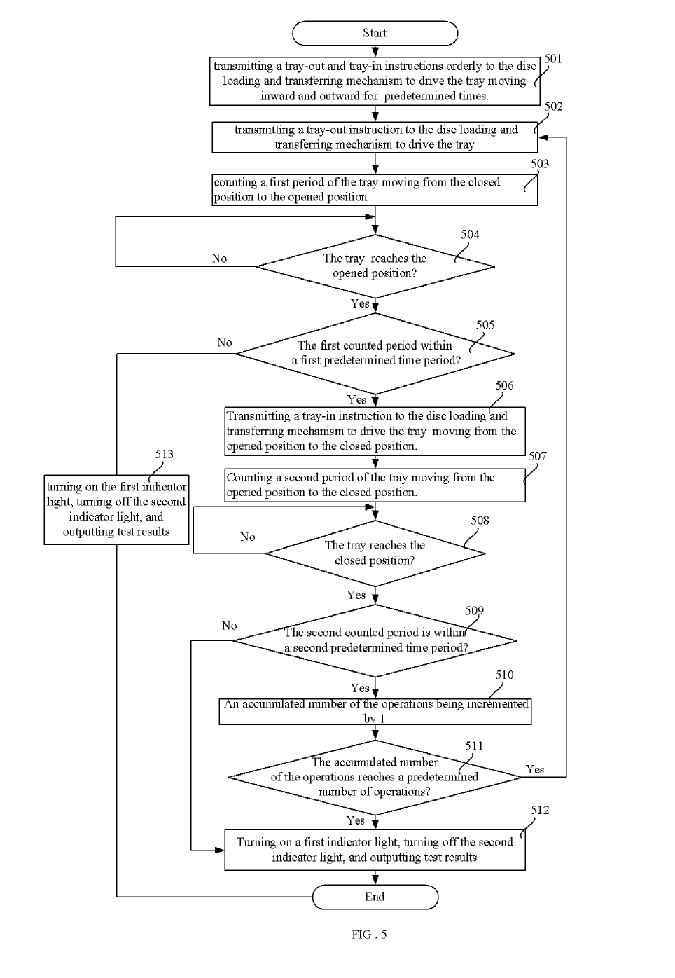

FIG. 5 shows a method applied to a testing device 30 for testing the disc loading and transferring mechanism 10. The testing device 30 includes a first indicator and a second indicator lights. The testing method includes the following steps:

In step S501, transmitting a tray-out and tray-in instructions in this order to the disc loading and transferring mechanism 10 to drive the tray 12 to move inward and outward for a first predetermined operation times.

In step S502, transmitting a tray-out instruction to the disc loading and transferring mechanism 10 to drive the tray 12 moving form a closed position to an opened position.

In step S503, counting a first period of the tray moving from the closed position to the opened position.

In step S504, detecting when the tray 12 reaches the opened position.

In step S505, stopping counting and determining whether the first counted period within a first predetermined time period when the tray reaches the opened position. The process goes to step S506 when the first counted period is within the first predetermined time period, and the process goes to step S513 when the first counted period is outside the predetermined time period.

In step S506, transmitting a tray-in instruction to the disc loading and transferring mechanism 10 to drive the tray 12 moving from the opened position to the closed position.

In step S507, counting a second period of the tray 12 moving from the opened position to the closed position.

In step S508, detecting when the tray 12 reaches the closed position. The process goes to step S509 when the tray 12 has reached the closed position, if not, the step S508 is repeated.

In step S509, ending the second counted period and determining whether the second counted period is within a second predetermined time period. The process goes to step S510 when the second counted period is within the second predetermined time period. The process goes to step S513, when the second counted period is outside the second predetermined time period.

In step S510, an accumulated number of the operations being incremented by 1. The accumulated number is 0 before.

In step S511, determining whether the accumulated number of the operations reaches a predetermined number of operations. The process goes to step S512 when the accumulated number of the operations reaches the predetermined number. The process goes to step S502 when the accumulated number of the operations does not reach the predetermined number.

In step S512, turning on a first indicator light, turning off the second indicator light, and outputting test results for indicating that the disc loading and transferring mechanism 10 is in conformity with predetermined and expected standards.

In step S512, turning on the first indicator light, turning off the second indicator light, and outputting test results for indicating that the disc loading and transferring mechanism 10 is in conformity with predetermined and expected standards.

In step S513, turning off the first indicator light, turning on the second indicator light, and outputting test results for indicating that the disc loading and transferring mechanism 10 is not in conformity with predetermined and expected standards.

As described above, the testing device 100 and the testing method can automatically test the disc loading and transferring mechanism 10, it will save a lot of time.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A testing device for testing a disc loading and transferring mechanism, the loading and transferring mechanism comprises a tray for loading a disc, the testing device comprising:
a transmitting unit to transmit a tray-out signal and a tray-in signal in that order to control the tray to alternate between a closed position and a opened position;
a detecting unit to detect whether the tray reaches the closed position and the opened position, and generates a counting instruction after the tray reaches the opened position and the closed position;
a counting unit to count a first period of the tray moving from the closed position to the opened position and a second period of the tray moving from the opened position to the closed position;
a determining unit to determine whether the first counted period and the second counted period are in conformity with predetermined and expected standards, and generates a stop instruction when the first counted period and the second counted period are not in conformity with predetermined and expected standards; and
an output unit to output test results for indicating the disc loading and transferring mechanism is not in conformity with predetermined and expected standards.

2. The testing device of claim 1, wherein the determining unit determines that the first and the second periods of counting are in conformity with predetermined and expected standards when the first counted period is within the first predetermined time period and the second counted period is within a second predetermined time period.

3. The testing device of claim 1, wherein the determining unit determines that the first and the second periods of counting are in conformity with predetermined and expected standards when the first counted period is within the first predetermined time period and the second counted period is within a second predetermined time period.

4. The testing device of claim 1, wherein the determining unit determines that the first and the second periods of counting are in conformity with predetermined and expected standards when the sum of the first period and the second counted period is within a predetermined time period.

5. The testing device of claim 1, further comprising a counting unit, the counting unit counting a number of operations of the tray moving from the closed position to the open position and back to the closed position when the first period and the second period are in conformity with predetermined and expected standards, the determining unit further determining whether the number of the counting operations reaches a predetermined number, when the number of the counting operations reaches a predetermined number, the counting unit further generating a second stop instruction to control the output unit to output test results for indicating the disc loading and transferring mechanism is not in conformity with predetermined and expected standards.

6. The testing device of claim 5, further comprising a fist indicator light and a second indicator light, the first indicator light turning on and the second indicator light turning off in response to the stop instruction, the first indicator light turning off and the second indicator light turning on in response to the ending instruction.

7. A testing method for testing a disc loading and transferring mechanism having a tray, the testing method comprising steps of:
transmitting a tray-out instruction and a tray-in instruction in that order to drive the tray to alternate between a closed position and an opened position;
counting a first period of the tray moving from the closed position to the opened position and a second period of the tray moving from the opened position to the closed position;
determining whether the first counted period and the second counted period are in conformity with predetermined and expected standards, and
outputting test results for indicating the disc loading and transferring mechanism is not in conformity with predetermined and expected standards when the first counted period and the second counted period are in conformity with predetermined and expected standards.

8. The testing method of claim 7, wherein the first and the second periods of counting are determined to be in conformity with predetermined and expected standards when the first counted period is within the first predetermined time period and the second counted period is within a second predetermined time period.

9. The testing method of claim 7, wherein the first and the second periods of counting are determined to be in conformity with predetermined and expected standards when sum of the first counted period and the second counted period is within a third predetermined time period.

10. The testing method of claim 7, further comprising steps of:
counting a number of operations of the tray moving from the closed position to the open position and back to the closed position when the first period and the second period are in conformity with predetermined and expected standards;
determining whether the number of the counting operations reaches a predetermined number; and
output test results for indicating the disc loading and transferring mechanism is not in conformity with predetermined and expected standards when the number of the of counting operations reaches the predetermined number.

11. The testing method of claim 10, further comprising step of:
turning on a first indicator light and turning off a second indicator light when the first period and the second period are not in conformity with predetermined and expected standards; and
turning off the first indicator light and turning on a second indicator light when the number of the of counting reaches the predetermined number.

12. The testing method of claim 11, wherein the first indicator light and the second indicator lights emits different color lights.
